(19) United States
(12) Patent Application Publication
(10) Pub. No.: US 2002/0149188 A1
(43) Pub. Date: Oct. 17, 2002

(54) Automatic vehicle slide detection and position correction system

(76) Inventor: Willis G. Major, Buffalo, NY (US)

Correspondence Address: WILLIS G. MAJOR, P.O. BOX 13655, ROCHESTER, NY, 14613, US

(21) Appl. No.: 09/836,005

(22) Filed: Apr. 17, 2001

(51) Int. Cl. B60S 9/00

(52) U.S. Cl. 280/757

(57) ABSTRACT

A vehicle anti-tire-slide onboard road gripping media dispensing safety system that dispenses road gripping media (such as salt, sand, and any other solid, liquid, or gaseous media which allows tires to grip the road during slippery road conditions (such as ice, snow, rain, mud, etc. . . . ). The vehicle anti-tire-slide onboard road gripping media dispensing safety system provides a safer, faster, more controlled deceleration of a vehicle when braking during slippery road conditions. It reduces potential accidents, reduces deaths, reduces insurance claims/rates, reduces salt truck expenses for cities and makes a driver feel safer when riding on slippery roads. It increases tire traction, allows for increased acceleration when taking off from a stand still, and it allows the driver to have more control on slippery roads at higher speeds. It allows a vehicle to become unstuck in snow, mud, on rainy, on icy ground and during other bad weather conditions. It also allows the driver behind you to stop safer and quicker due to releasing media from the rear of your vehicle. The vehicle safety anti-tire-slide onboard road gripping media dispensing safety system main parts generally comprise of a cover (10), container (60), and release mechanism (190), nozzle (400), road gripping media (450), trigger/selector switch (490), media low level display (500), media low level sensor (510), car movement sensor (520), wheel rotation sensor (530), heating element (540), connector (550), cable/wire (560), and controller/computer (570).

### CROSS-REFERENCE TO RELATED APPLICATIONS

Not applicable

### BACKGROUND

1. Field of Invention

This invention relates to “vehicle anti-tire-slide onboard road gripping media dispensing safety systems” that dispense road gripping media (such as salt, sand, and any other solid, liquid, or gaseous media which allows tires to grip the road during slippery road conditions (such as ice, snow, rain, mud, etc. . . . ).

2. Description of Prior Art

Currently, there are two major ways that attempt to help drivers safely stop their vehicle when bad road conditions exist (road has ice, snow, rain, mud, etc. . . . on it, making the road slippery). The first attempt is to equip a vehicle with anti-lock brakes or tires that have special tread that improves the ability of the car to safely stop during bad (slippery) road conditions. The problem with the existing methods above is they are not effective enough to prevent drivers from getting stuck or don't allow the driver enough control to safely prevent vehicle accidents.

The second attempt to help drivers stop safely, when roads are slippery, consists of snow & salt trucks removing snow and putting down salt over the roads. There are two major problems with this existing method.

First, although we appreciate salt being put down on the roads we always find roads that are in need of salt. It is difficult and expensive to predict when there is snow and to always send out enough snow and salt trucks to cover all areas of the road in a timely fashion. This disability is what causes drivers to continue to ride on roads that have snow or ice and get into accidents (from not being able to stop safely).

The second problem is that snow & salt trucks only are used for snow and ice. There are no trucks that put down any media for slick roads due to mud or rain in the summer time.

Lastly, when a driver is stuck (in snow, ice, mud, etc. . . . ), the existing methods provides no assistance to the driver. The driver has to dig his car out of the stuck condition, put salt under the tire, or get pushed/towed out of the stuck condition.

The above existing systems have many inadequacies in trying to help drivers safely stop or control their vehicles on slippery roads or help a driver's vehicle become unstuck (from ice, snow, mud, and etc. . . . ). Therefore, a significant need has arose for a “vehicle anti-tire-slide onboard road gripping media dispensing safety system” that dispenses road gripping media (such as salt, sand, other solid, liquid, or gaseous media) which allow tires to grip the road during slippery road conditions (such as ice, snow, rain, mud, etc. . . . ).

### SUMMARY

In accordance with the present invention the “vehicle anti-tire-slide onboard road gripping media dispensing safety system” comprises a cover, container, release mechanism, nozzle, road gripping media, trigger/selector switch, media low level display, media low level sensor, car movement sensor, wheel rotation sensor, controller/computer, connector, cable, and heating element.

### OBJECTS AND ADVANTAGES

Accordingly, several objects and advantages of the “vehicle anti-tire-slide onboard road gripping media dispensing safety system” described in my above patent are:

(a) to provide a shorter time to stop vehicles by releasing road gripping media from said vehicles in various directions for the purpose of making effective contact with tires to minimize tire slippage when braking;

(b) to provide a shorter stopping distance for vehicles by releasing road gripping media from said vehicles in various directions for the purpose of making effective contact with tires to minimize tire slippage when braking;

(c) to provide increased deceleration for vehicles by releasing road gripping media from said vehicles in various directions for the purpose of making effective contact with tires to minimize tire slippage when braking;

(d) to provide increased acceleration for vehicles when they are taking off from a stopped position by releasing road gripping media from said vehicles in various directions for the purpose of making effective contact with tires to minimize tire slippage;

(e) to provide a reduction in the amount of sliding (in all directions) a vehicle does by releasing road gripping media from said vehicles in various directions for the purpose of making effective contact with tires to minimize tire slippage;

(f) to provide more accurate and efficient steering control of vehicles by releasing road gripping media from said vehicles in various directions for the purpose of making effective contact with tires to minimize tire slippage;

(g) to provide a means to bring vehicles under control by releasing road gripping media from said vehicles in various directions for the purpose of making effective contact with tires to minimize tire slippage;

(h) to provide a safer way to stop vehicles by releasing road gripping media from said vehicles in various directions for the purpose of making effective contact with tires to minimize tire slippage when braking;

(i) to provide a reduction in the number of vehicle accidents by releasing road gripping media from said vehicles in various directions for the purpose of making effective contact with tires to minimize tire slippage;

(j) to provide a reduction in deaths and injuries during vehicle accidents by releasing road gripping media from said vehicles in various directions for the purpose of making effective contact with tires to minimize tire slippage when braking and provide for safe stopping;

(k) to provide a better way for vehicles behind you to safely stop and not run into the back end of your vehicle by releasing road gripping media from the back of your vehicle in various directions for the purpose of allowing it to make effective contact with the tires of the vehicle behind you to minimize their tire slippage when braking;

(l) to provide a reduction in insurance rates, cost, claims, etc. . . . , by providing a system that increases the safety of people & vehicles;

(m) to provide a reduction in salt truck expenses for cities;

(n) to provide increased tire traction for vehicles by releasing road gripping media from said vehicles in various directions for the purpose of making effective contact with tires to minimize tire slippage;

(o) to provide drivers with a safer feeling when driving their vehicle during bad weather and slippery road conditions;

(p) to provide a way to help vehicles become unstuck when they become stuck in mud, ice, rain, snow, etc . . . ;

(q) to provide a way to help vehicles be driven safely at higher speeds during bad weather and still stop safely by releasing road gripping media from said vehicles in various directions for the purpose of making effective contact with tires to minimize tire slippage;

Further objectives and advantages of my invention will become apparent from a consideration of the drawings and ensuing description.

### DRAWING FIGURES

In drawings, closely related figures have the same number but different alphabetic suffixes.

In accordance with the present invention a “vehicle anti-tire-slide onboard road gripping media dispensing safety system” comprises a cover, container, release mechanism, nozzle, road gripping media, trigger/selector switch, media low level display, media low level sensor, car movement sensor, wheel rotation sensor, controller, connector, cable, and heating elements.

FIGS. 1A to 1M show some of the various configurations and various road gripping media release mechanisms that the “vehicle anti-tire-slide onboard road gripping media dispensing safety system” can be comprised of, 1A) vane-motor dispenser, 1B) external ball-shaft-solenoid dispenser, 1C) internal ball-shaft-solenoid dispenser, 1D) rotating cup dispenser, 1E) sliding-stop-solenoid dispenser, 1F) sliding-stop-motor dispenser, 1G) rotating-plate-solenoid dispenser, 1H) rotating-plate-motor dispenser, 1I) double-flap-door-solenoid dispenser, 1J) vane-internal-ball-solenoid dispenser, 1K) double-flap-door-internal-ball-solenoid dispenser, 1L) liquid-solenoid-controlled dispenser, 1M) liquid-spring-controlled dispenser, to show a few variations but not to limit all other possible dispensing designs.

### REFERENCE NUMERALS IN DRAWINGS

010 cover

020 cover—threads

030 cover—retaining bead

040 cover—holes

050 cover—screw

060 container

070 container—media entrance hole

080 container—threaded screw hole

090 container—retaining bead

100 container—supports

110 container—media exit hole

120 container—base

130 container—top

140 container—side

150 container—bracket attachment

160 container—nozzle attachment

170 container—solenoid-spring-shaft-ball-holder

180 container—media sealing surface

190 release mechanism

200 release mechanism—motor

210 release mechanism—ball

220 release mechanism—sealing stop

230 release mechanism—rotating vane

240 release mechanism—rotating cup

250 release mechanism—double door flaps

260 release mechanism—door flap pivot hinge

270 release mechanism—sealing surface

280 release mechanism—sliding stop & shaft assembly

290 release mechanism—solenoid-spring-stop-shaft holder

300 release mechanism—shaft

310 release mechanism—motor gear

320 release mechanism—spring

330 release mechanism—solenoid

340 release mechanism—rotating door flap opener

350 release mechanism—motor holder

360 release mechanism—piston

370 release mechanism—valve

380 release mechanism—pump

390 release mechanism—shaft gear end

391 release mechanism—rotating plate

392 release mechanism—rotating plate & shaft connection

393 release mechanism—rotating plate with gears

400 nozzle

410 nozzle solenoid

420 nozzle ball

430 nozzle spring

440 nozzle guide

450 road gripping media

460 gaseous road gripping media

470 liquid road gripping media

480 solid road gripping media

490 trigger/selector switch

500 media low level display

510 media low level sensor

520 car movement sensor

530 wheel rotation sensor

540 heating element

550 connector

560 cable/wire

570 controller/computer

### DESCRIPTION

FIG. 3C—Preferred Solid Media Dispenser Embodiment

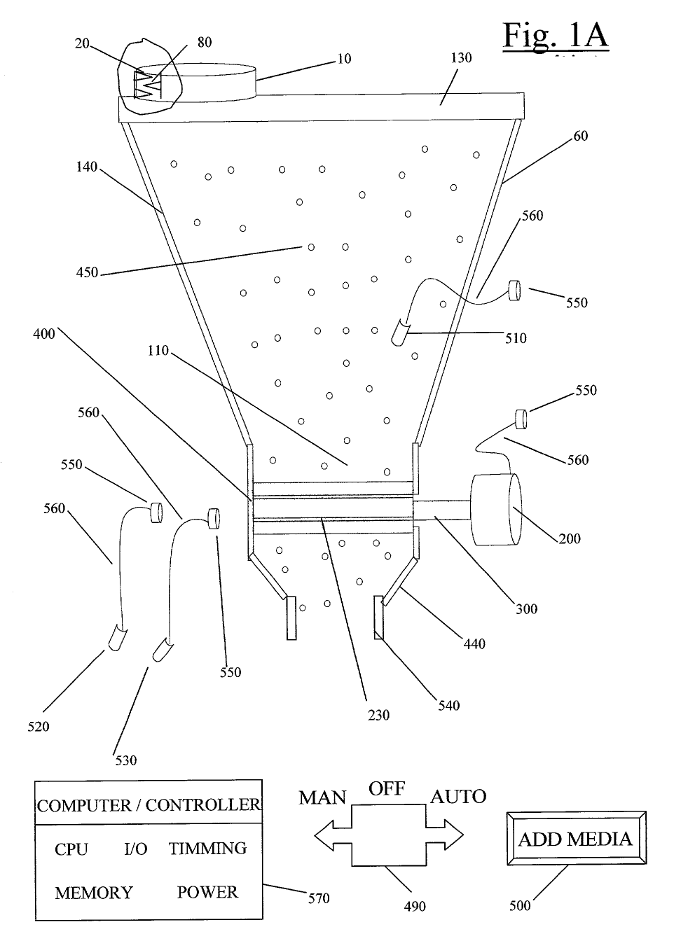

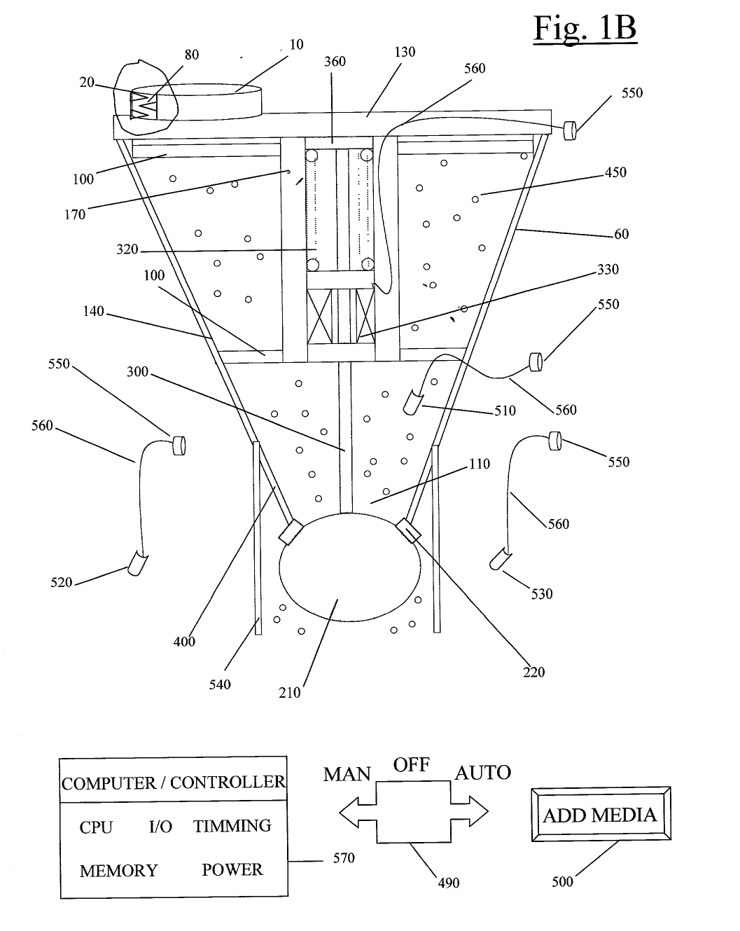

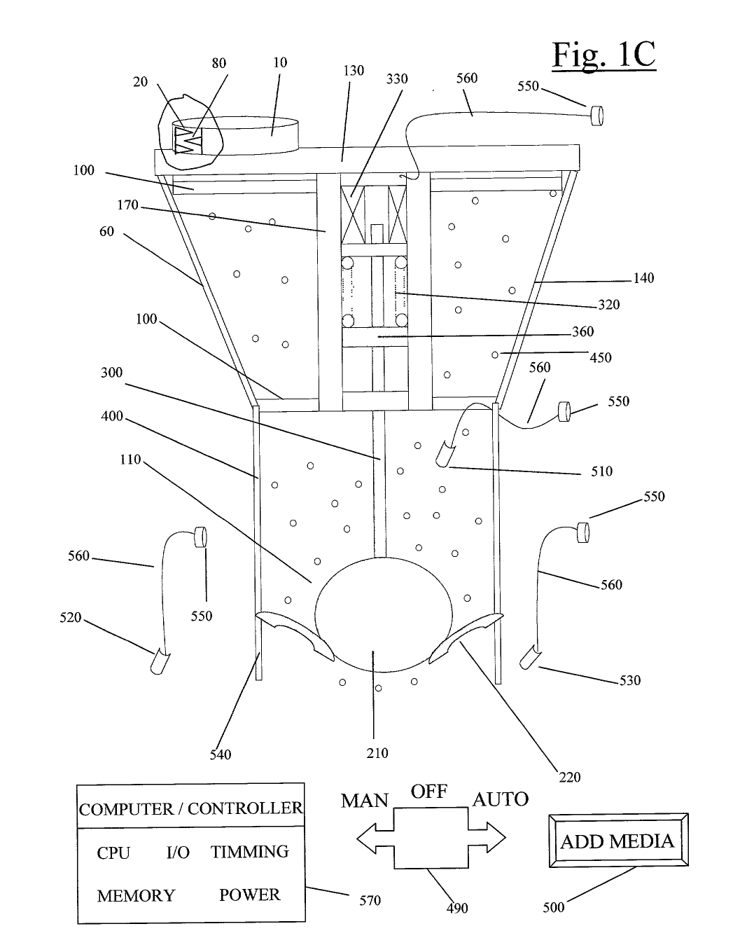

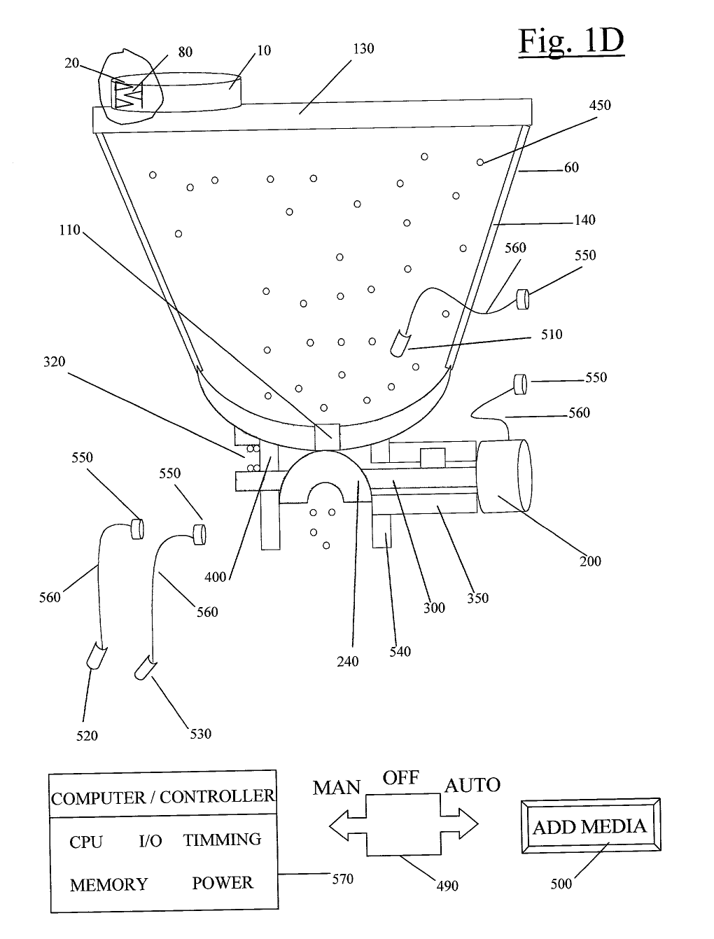

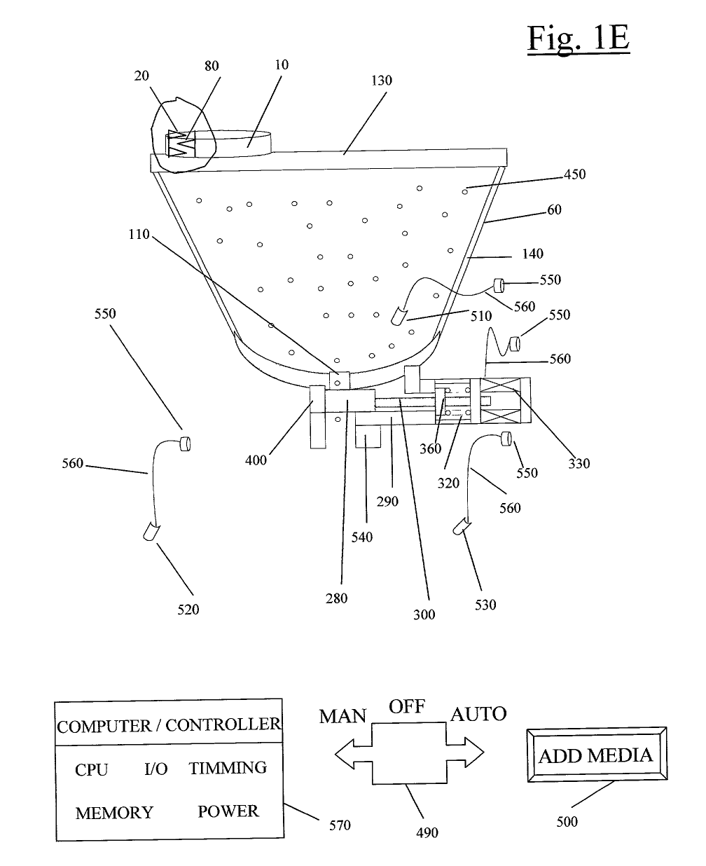

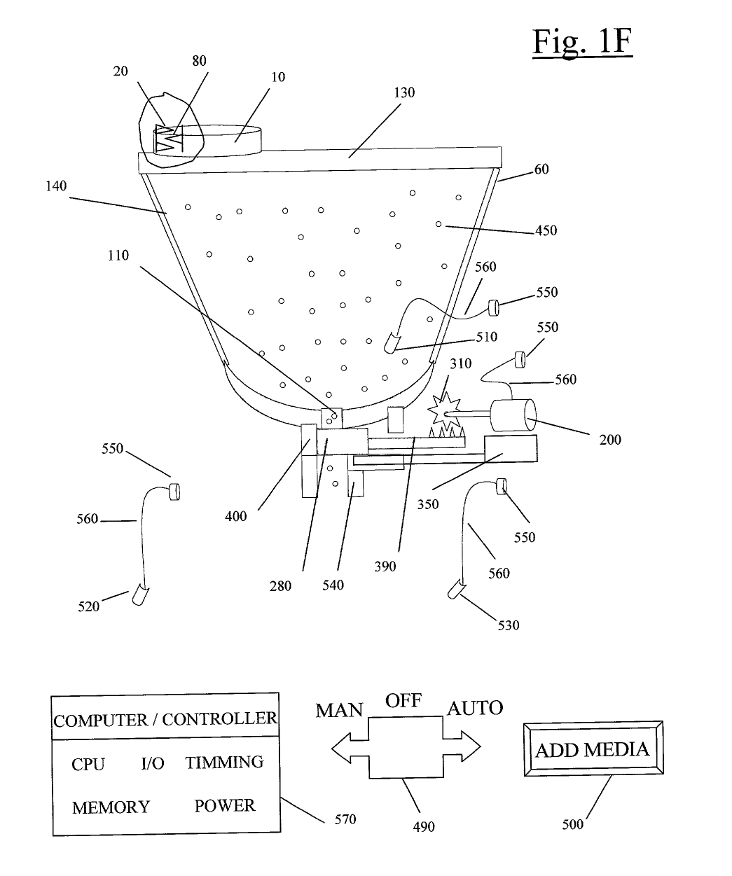

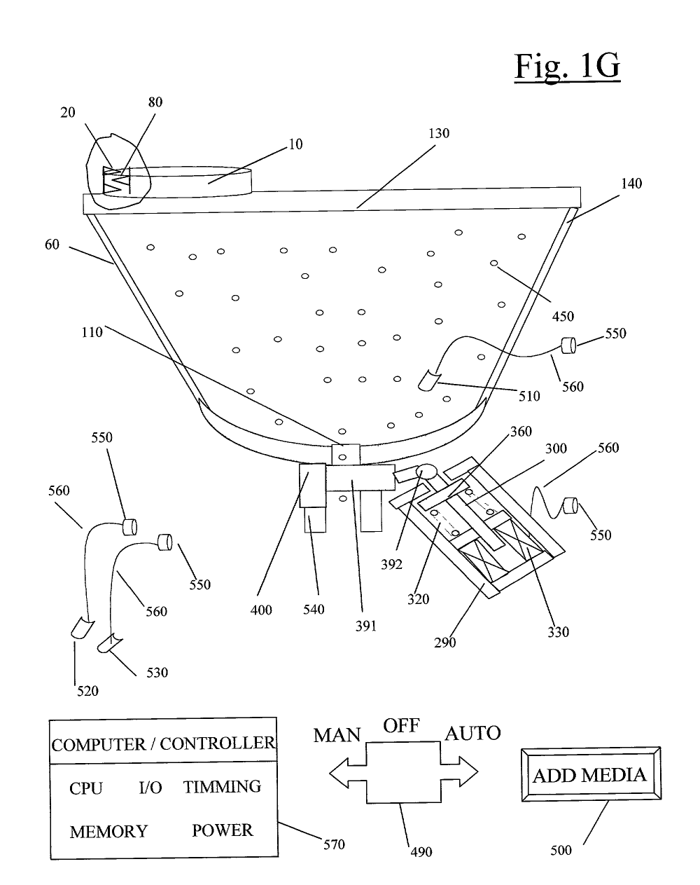

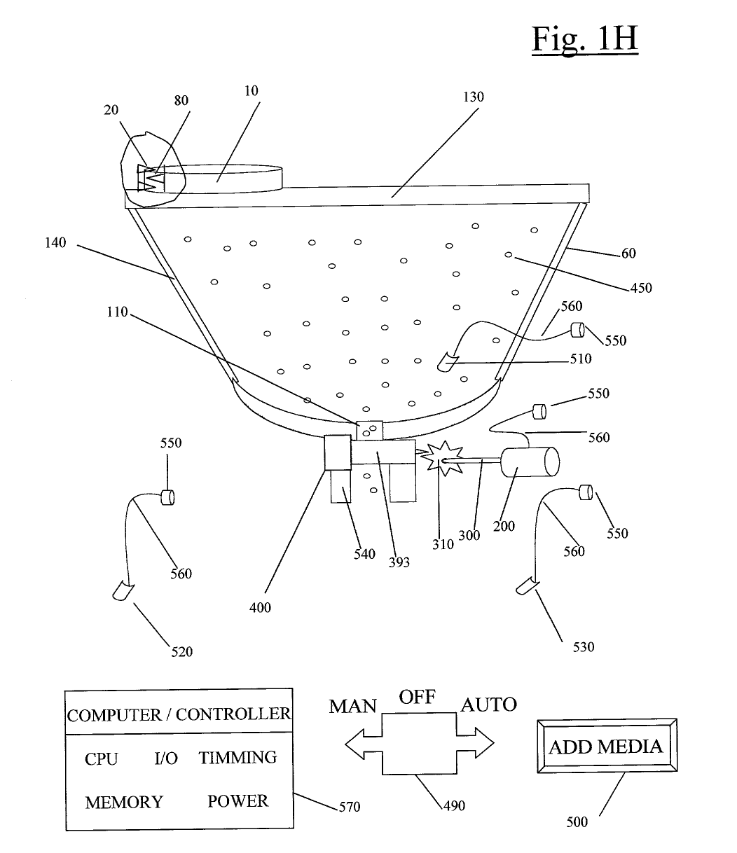

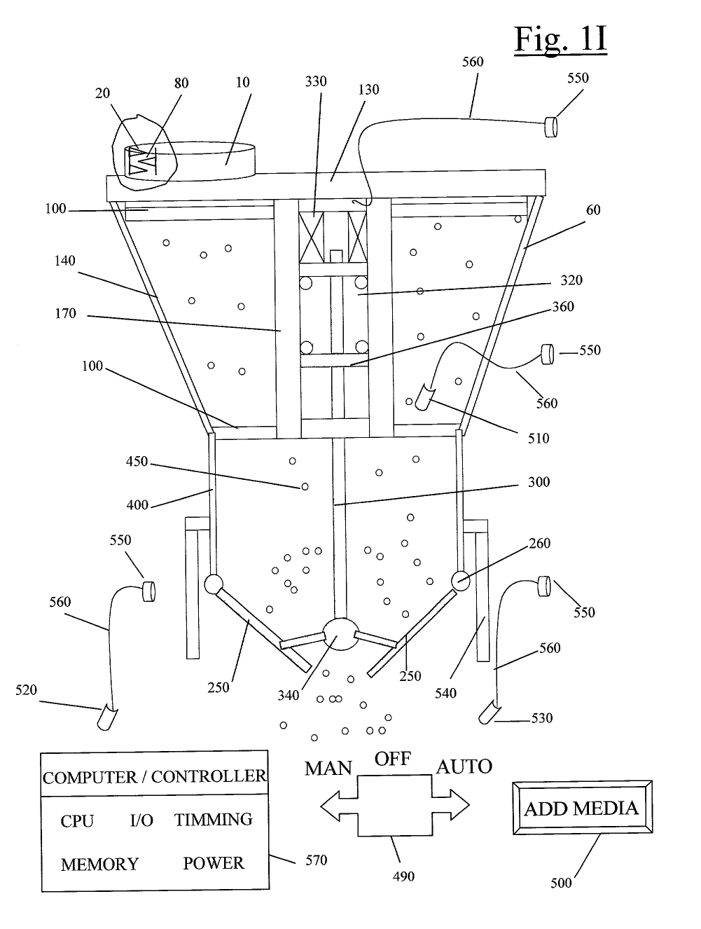

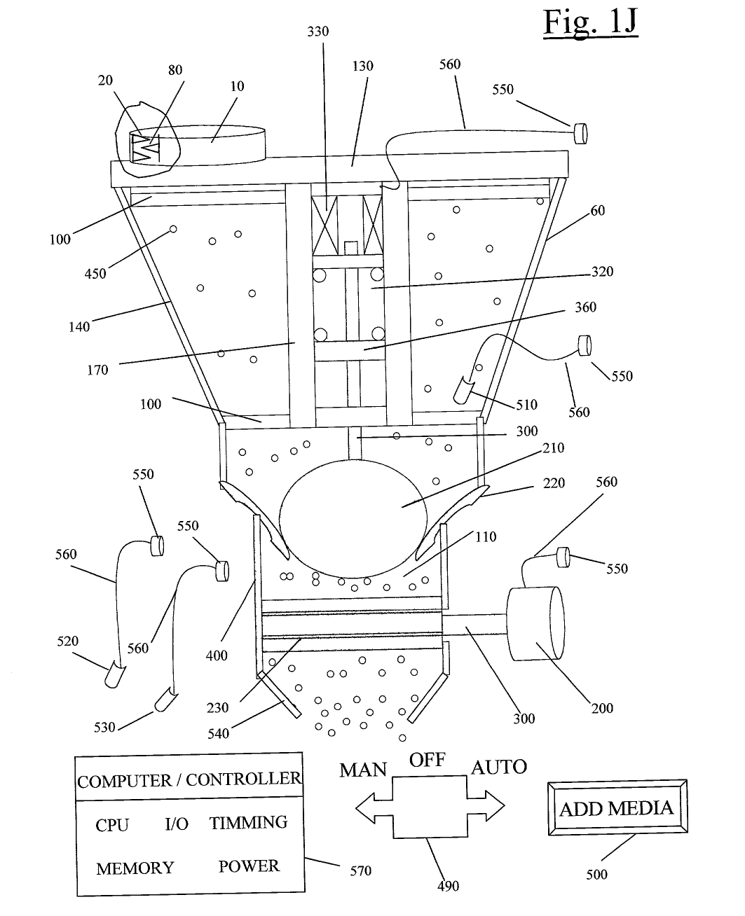

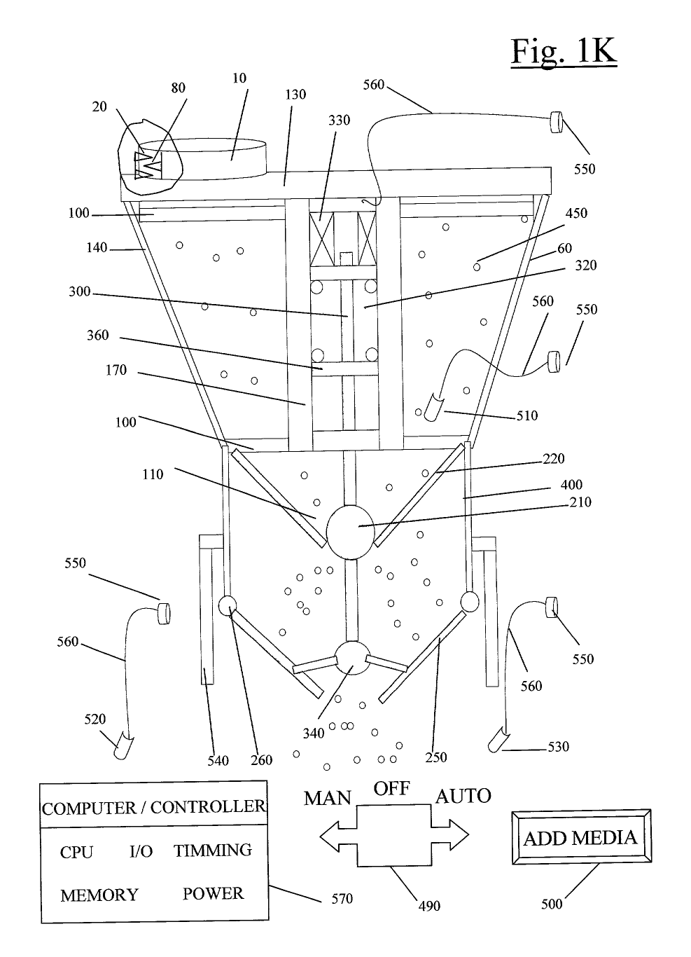

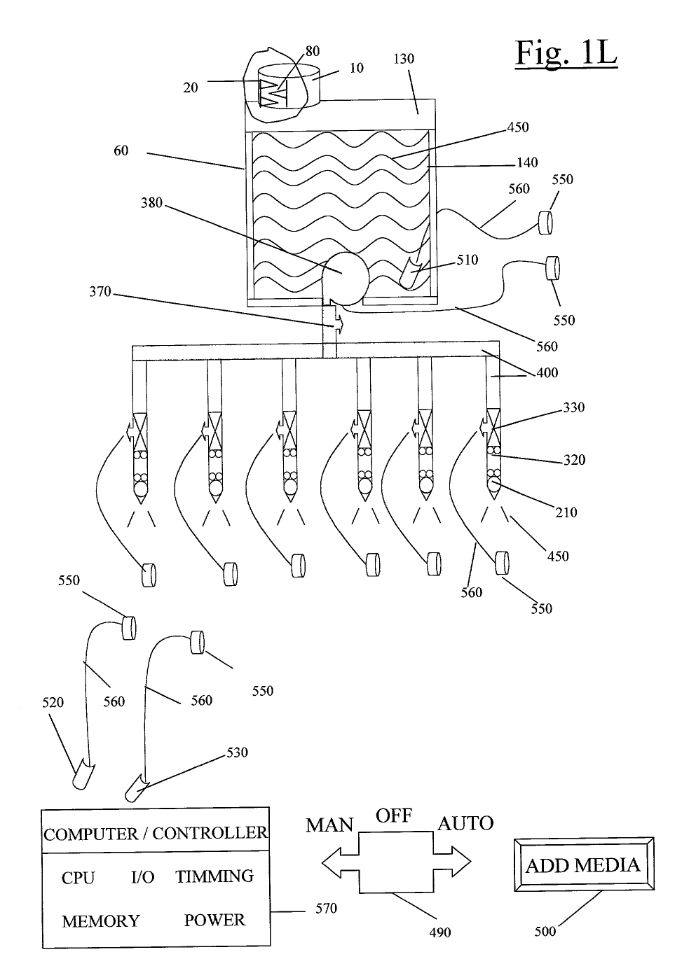

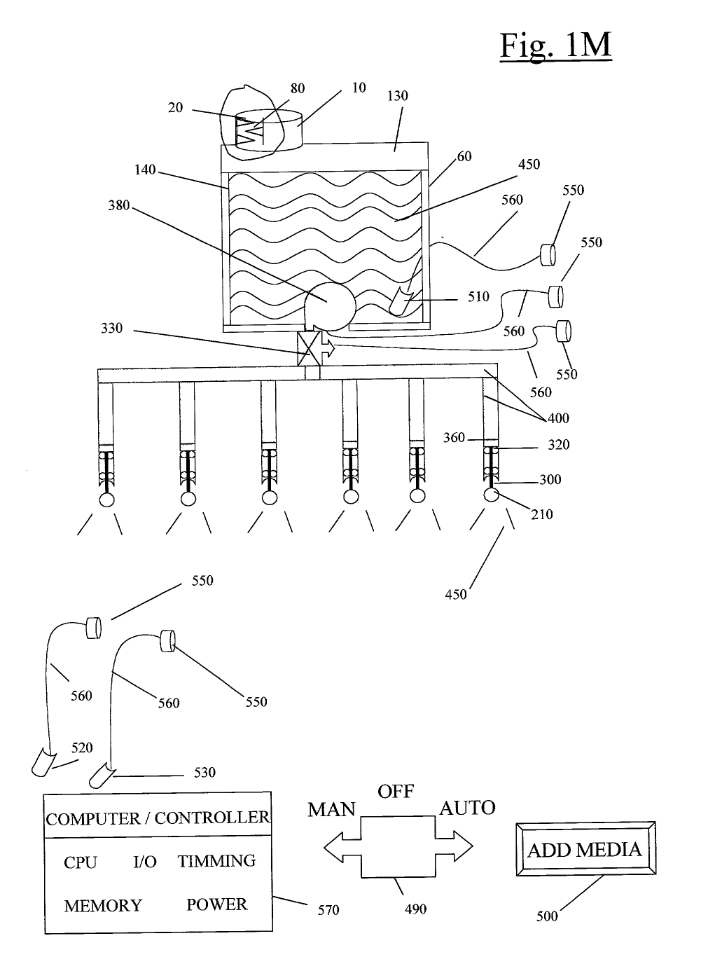

A preferred embodiment of the vehicle safety anti-tire-slide onboard road gripping media dispensing system is illustrated in FIG. 1A (the vane-motor dispenser release mechanism). The vehicle safety anti-tire-slide onboard road gripping media dispensing safety system main parts generally comprise of a cover 10, container 60, and release mechanism 190, nozzle 400, road gripping media 450, trigger/selector switch 490, media low level display 500, media low level sensor 510, car movement sensor 520, wheel rotation sensor 530, heating element 540, connector 550, cable/wire 560, and controller/computer 570.

The cover 10, includes cover threaded ID hole 20.

The container 60, includes container media threaded OD entrance hole 80, container media exit hole 110, container top 130, container side 140, container bracket attachment 150, container nozzle attachment 160.

The cover 10, is attached to the container 60, where the cover threaded ID hole 20, meets the container media threaded OD entrance hole 80.

The container 60, is attached to the vehicle where the container bracket attachment 150 meets the vehicle.

The nozzle 400, is attached to the container 60, where the container nozzle attachment 160, meets the nozzle 400.

The release mechanism 190, includes a release mechanism motor 200, a release mechanism rotating vane 230, and a release mechanism shaft 300.

The release mechanism 190, is attached to the nozzle 400, where the nozzle 400, meets the release mechanism rotating vane 230. The release mechanism rotating vane 230, is attached to the release mechanism shaft 300, which is attached to the release mechanism motor 200. The release mechanism motor 200, has a connector 550, and cable/wire 560.

The road gripping media 450, consist of solid road gripping media 480. The solid road gripping media 480, is poured into the container media threaded OD entrance hole 80, and fills up the container 60.

The media low level sensor 510, is located inside of the container 60, and sends a signal when more road gripping media 450, is needed. The media low level sensor 510, has a connector 550, and cable/wire 560.

The heating element 540, is located inside or/and outside of the container 60, and/or nozzle 400. The heating element 540 has a connector 550, and cable/wire 560.

The trigger/selector switch 490, and media low level display 500, is located within the vehicle for driver use and both have a connector 550, and cable/wire 560.

The car movement sensor 520, and wheel rotation sensor 530, is mainly located underneath the vehicle and both have a connector 550, and cable/wire 560.

The controller/computer 570, receives inputs from the media low level sensor 510, car movement sensor 520, wheel rotation sensor 530, trigger/selector switch 490, and sends outputs to the heating element 540, media low level display 500, and release mechanism motor 200, based on the logic that the controller/computer is programmed with on how to react to input and output signals.

FIG. 3C—Preferred Liquid/Gas Media Dispenser Embodiment

A preferred embodiment of the vehicle anti-tire-slide onboard road gripping media dispensing safety system is illustrated in FIG. 1M (the liquid-spring-controlled dispenser). The vehicle safety anti-tire-slide onboard road gripping media dispensing safety system main parts generally comprise of a cover 10, container 60, and release mechanism 190, nozzle 400, road gripping media 450, trigger/selector switch 490, media low level display 500, media low level sensor 510, car movement sensor 520, wheel rotation sensor 530, heating element 540, connector 550, cable/wire 560, and controller/computer 570.

The cover 10, includes cover threaded ID hole 20.

The container 60, includes container media threaded OD entrance hole 80, container media exit hole 110, container top 130, container side 140, container bracket attachment 150.

The cover 10, is attached to the container 60, where the cover threaded ID hole 20, meets the container media threaded OD entrance hole 80.

The container 60, is attached to the vehicle where the container bracket attachment 150 meets the vehicle.

The release mechanism 190, includes a release mechanism pump 380, a release mechanism solenoid 330, a release mechanism ball 210, a release mechanism shaft 300, a release mechanism spring 320, a release mechanism piston 360, and nozzle 400.

The release mechanism pump 380, is attached to the container media exit hole 110, at one end and connected to the release mechanism solenoid 330, at the other end. The release mechanism solenoid 330, is attached to the multiple nozzles 400. The nozzles 400, extend out to various locations around the vehicle and aim at a multitude of places on the ground and on the vehicle tires. The nozzles 400, are attached to the release mechanism piston 360, release mechanism shaft 300, release mechanism ball 210, and release mechanism spring 320.

The release mechanism pump 380, and release mechanism solenoid 330, both has a connector 550, and cable/wire 560.

The road gripping media 450, consist of liquid road gripping media 470, or gaseous road gripping media 460. The road gripping media 450, is poured into the container media threaded OD entrance hole 80, and fills up the container 60.

The media low level sensor 510, is located inside of the container 60, and sends a signal when more road gripping media 450, is needed. The media low level sensor 510, has a connector 550, and cable/wire 560.

The heating elements 540, is located inside or/and outside of the container 60, and/or nozzle 400. The heating element 540 has a connector 550, and cable/wire 560.

The trigger/selector switch 490, and media low level display 500, is located within the vehicle for driver use and both have a connector 550, and cable/wire 560.

The car movement sensor 520, and wheel rotation sensor 530, is located mainly underneath the vehicle and both have a connector 550, and cable/wire 560.

The controller/computer 570, receives inputs from the media low level sensor 510, car movement sensor 520, wheel rotation sensor 530, trigger/selector switch 490, and sends outputs to the heating element 540, media low level display 500, and release mechanism motor 200, based on the logic that the controller/computer is programmed with on how to react to input and output signals.

FIGS. 1B-1L—Additional/Alternative Embodiments

Additional/Alternative embodiments are shown in FIGS. 1B through 1L. FIG. 1B shows the release mechanism 190, having an external ball-shaft-solenoid dispenser. FIG. 1C shows the release mechanism 190, having an internal ball-shaft-solenoid dispenser. FIG. 1D shows the release mechanism 190, having a rotating cup dispenser. FIG. 1E shows the release mechanism 190, having a sliding-stop-solenoid dispenser. FIG. 1F shows the release mechanism 190, having a sliding-stop-motor dispenser. FIG. 1G shows the release mechanism 190, having a rotating-plate-solenoid dispenser. FIG. 1H shows the release mechanism 190, having a rotating-plate-motor dispenser. FIG. 11 shows the release mechanism 190, having a double-flap-door-solenoid dispenser. FIG. 1J shows the release mechanism 190, having a vane-internal-ball-solenoid dispenser. FIG. 1K shows the release mechanism 190, having a double-flap-door-internal-ball-solenoid dispenser. FIG. 1L shows the release mechanism 190, having a liquid-solenoid-controlled dispenser.

Advantages

From the description above, a number of advantages of my “vehicle anti-tire-slide onboard road gripping media dispensing safety system become evident:

(a) provides a shorter time to stop vehicles by releasing road gripping media from said vehicles in various directions for the purpose of making effective contact with tires to minimize tire slippage when braking;

(b) provides a shorter stopping distance for vehicles by releasing road gripping media from said vehicles in various directions for the purpose of making effective contact with tires to minimize tire slippage when braking;

(c) provides increased deceleration for vehicles by releasing road gripping media from said vehicles in various directions for the purpose of making effective contact with tires to minimize tire slippage when braking;

(d) provides increased acceleration for vehicles when they are taking off from a stopped position by releasing road gripping media from said vehicles in various directions for the purpose of making effective contact with tires to minimize tire slippage;

(e) provides a reduction in the amount of sliding (in all directions) a vehicle does by releasing road gripping media from said vehicles in various directions for the purpose of making effective contact with tires to minimize tire slippage;

(f) provides more accurate and efficient steering control of vehicles by releasing road gripping media from said vehicles in various directions for the purpose of making effective contact with tires to minimize tire slippage;

(g) provides a means to bring vehicles under control by releasing road gripping media from said vehicles in various directions for the purpose of making effective contact with tires to minimize tire slippage;

(h) provides a safer way to stop vehicles by releasing road gripping media from said vehicles in various directions for the purpose of making effective contact with tires to minimize tire slippage when braking;

(i) provides a reduction in the number of vehicle accidents by releasing road gripping media from said vehicles in various directions for the purpose of making effective contact with tires to minimize tire slippage;

(j) provides a reduction in deaths and injuries during vehicle accidents by releasing road gripping media from said vehicles in various directions for the purpose of making effective contact with tires to minimize tire slippage when braking and provide for safe stopping;

(k) provides a better way for vehicles behind you to safely stop and not run into the back end of your vehicle by releasing road gripping media from the back of your vehicle in various directions for the purpose of allowing it to make effective contact with the tires of the vehicle behind you to minimize their tire slippage when braking;

(l) provides a reduction in insurance rates, cost, claims, etc. . . . , by providing a system that increases the safety of people & vehicles;

(m) provides a reduction in salt truck expenses for cities;

(n) provides increased tire traction for vehicles by releasing road gripping media from said vehicles in various directions for the purpose of making effective contact with tires to minimize tire slippage;

(o) provides drivers with a safer feeling when driving their vehicle during bad weather and slippery road conditions;

(p) provides a way to help vehicles become unstuck when they become stuck in mud, ice, rain, snow, etc. . . . ;

(q) provides a way to help vehicles be driven safely at higher speeds during bad weather and still stop safely by releasing road gripping media from said vehicles in various directions for the purpose of making effective contact with tires to minimize tire slippage;

Operation (Vane-Motor Dispenser with Solid Road Gripping Media)

Remove cover by unscrewing it and pour solid road gripping media into the container. The media low level switch will turn on and remove the low level warning from the media low level display once the container is filled to an adequate amount. Screw cover back on tight. When driving along in the automatic dispensing mode, the wheel rotation sensor monitors the wheel for non-rotation (brakes applied) and will send a signal to the controller/computer indicating that the wheel has stopped turning. At the same time, the controller/computer is waiting for a signal from the car motion sensor that will indicate that the car is still in motion. This sensor monitors ground movement relative to the car and will send a signal to the controller when it senses that the car is in motion relative to the ground. When both wheel rotation and car motion sensors send out a signal to the controller/computer, this indicates that the car is in a slide condition. Therefore the controller/computer responds to these input signals by sending an output to the release mechanism motor, which turns the release mechanism vane, and this allows road gripping media to be released from the container. The nozzle will direct the road gripping media onto the tires of a vehicle, onto the ground in the predicted path of the tires, or into a possible car sliding direction. The heating element is used to heat snow/ice/media to ensure that the road gripping media has a clear path to the ground or tires. While driving along in the manual mode or any other mode of operation, the media trigger switch can be manually activated and this will force the release mechanism motor to turn the release mechanism vane dumping road gripping media onto the road or tires. Once the road gripping media comes into contact with the tires, the amount of slide of the vehicle will decrease allowing better braking, due to increased tire traction and will allow the vehicle to come to a safer stop. While stuck on a road/driveway, the media trigger switch can be manually activated to operate the release mechanism motor to turn the release mechanism vane and release road gripping media onto the tires which will increase tire traction and allow the vehicle to become unstuck. When there is a low level of road gripping media in the container, a low media level warning will be displayed on the low media level display, inside of the vehicle. This warning tells the driver when it is time to add more road gripping media to the container.

Operation (Liquid-Spring-Controlled Dispenser with Liquid/Gaseous Road Gripping Media)

Remove cover by unscrewing it and pour liquid/gaseous road gripping media into the container. The media low level switch will turn on and remove the low level warning from the media low level display once the container is filled to an adequate amount. Screw cover back on tight. When driving along in the automatic dispensing mode, the wheel rotation sensor monitors the wheel for non-rotation (brakes applied) and will send a signal to the controller/computer indicating that the wheel has stopped turning. At the same time, the controller/computer is waiting for a signal from the car motion sensor that will indicate that the car is in motion. This sensor monitors ground movement relative to the car and will send a signal to the controller when it senses that the car is in motion relative to the ground. When both wheel rotation and car motion sensors send out a signal to the controller/computer, this indicates that the car is in a slide condition. Therefore the controller/computer responds to these input signals by sending an output to the release mechanism pump and solenoid which allows pressure to build up in the release mechanism nozzle until the release mechanism spring force is overcame. When this force is overcame then the release mechanism ball will extend allowing liquid/gaseous road gripping media to flow onto the tires of a vehicle, onto the ground in the predicted path of the tires, or into a possible vehicle sliding direction. The heating element is used to heat snow, ice, or media to ensure that the road gripping media has a clear path to the ground or tires. While driving along in the manual mode or any other mode of operation, the media trigger switch can be manually activated and this will force the release mechanism pump and solenoid to become activated which allows liquid/gaseous pressure to build up in the release mechanism nozzle until the release mechanism spring force is overcame. When this force is overcame then the release mechanism ball will extend allowing liquid/gaseous road gripping media to flow onto the tires of a vehicle, onto the ground in the predicted path of the tires, or into a possible vehicle sliding direction. Once the road gripping media comes into contact with the tires, the amount of slide of the vehicle will decrease and better braking will occur due to increased tire traction and this will allow the vehicle to come to a safer stop. While stuck on a road/driveway, the media trigger switch can be manually activated and this will force the release mechanism pump and solenoid to become activated which allows liquid/gaseous pressure to build up in the nozzles until the release mechanism spring force is overcame. When this force is overcame then the release mechanism ball will extend allowing liquid/gaseous road gripping media to flow onto the tires of a vehicle which will increase tire traction and allow the vehicle to become unstuck. When there is a low level of road gripping media in the container, a low media level warning will be displayed on the low media level display inside of the vehicle. This warning tells the driver when it is time to add more road gripping media to the container.

Operation of Additional/Alternative Embodiments

Additional and Alternative embodiments operate the same as above with the exception of the release mechanism dispensing methods. In FIG. 1B the controller/computer sends a signal to the release mechanism solenoid and it extends the external ball downward allowing road gripping media to exit the container. In FIG. 1 C the controller/computer sends a signal to the release mechanism solenoid and it retracts the internal ball upward allowing road gripping media to exit the container. In FIG. 1D the controller/computer sends a signal to the release mechanism motor and the motor rotates the release mechanism rotating cup, allowing road gripping media to exit the container. In FIG. 1E the controller/computer sends a signal to the release mechanism solenoid and the release mechanism sliding stop retracts clearing the container media exit hole and allowing road gripping media to exit the container. In FIG. 1F the controller/computer sends a signal to the release mechanism motor and the release mechanism gear is turned which retracts the release mechanism sliding stop clearing the container media exit hole and allowing road gripping media to exit the container. In FIG. 1G the controller/computer sends a signal to the release mechanism solenoid and the release mechanism rotating plate turns until the opening in the rotating plate matches the opening in the container media exit hole allowing road gripping media to exit the container. In FIG. 1H the controller/computer sends a signal to the release mechanism motor that turns the release mechanism gear and then rotates the release mechanism rotating plate until the opening in the rotating plate matches the opening in the container media exit hole allowing road gripping media to exit the container. In FIG. 1I the controller/computer sends a signal to the release mechanism solenoid and the release mechanism double door flaps opens allowing road gripping media to exit the container. In FIG. 1J the controller/computer sends a signal to the release mechanism solenoid and it retracts the internal ball upward allowing road gripping media to exit the container and land onto the motionless release mechanism vane. When the release mechanism solenoid is deactivated the release mechanism internal ball moves back down blocking additional road gripping media from exiting the container and the release mechanism motor rotates the vane allowing road gripping media to be released onto tires and/or the road. In FIG. 1K the controller/computer sends a signal to the release mechanism solenoid and it retracts the internal ball upward allowing road gripping media to exit the container and lands onto the closed release mechanism double door flaps. When the release mechanism solenoid is deactivated the release mechanism internal ball moves back down blocking additional road gripping media from exiting the container and the double door flaps open up allowing road gripping media to be released onto tires and/or the road. In FIG. 1L the release mechanism pump and each individual solenoid is energized to overcome spring load that allows liquid/gaseous road gripping media to exit the release mechanism nozzle onto the vehicle tires and onto the road.

Conclusions, Ramifications, and Scope

Accordingly, the reader will see that the vehicle anti-tire-slide onboard road gripping media dispensing safety system of this invention has advantages in that

(a) it provides a shorter time to stop vehicles by releasing road gripping media from said vehicles in various directions for the purpose of making effective contact with tires to minimize tire slippage when braking;

(b) it provides a shorter stopping distance for vehicles by releasing road gripping media from said vehicles in various directions for the purpose of making effective contact with tires to minimize tire slippage when braking;

(c) it provides increased deceleration for vehicles by releasing road gripping media from said vehicles in various directions for the purpose of making effective contact with tires to minimize tire slippage when braking;

(d) it provides increased acceleration for vehicles when they are taking off from a stopped position by releasing road gripping media from said vehicles in various directions for the purpose of making effective contact with tires to minimize tire slippage;

(e) it provides a reduction in the amount of sliding (in all directions) a vehicle does by releasing road gripping media from said vehicles in various directions for the purpose of making effective contact with tires to minimize tire slippage;

(f) it provide more accurate and efficient steering control of vehicles by releasing road gripping media from said vehicles in various directions for the purpose of making effective contact with tires to minimize tire slippage;

(g) it provides a means to bring vehicles under control by releasing road gripping media from said vehicles in various directions for the purpose of making effective contact with tires to minimize tire slippage;

(h) it provides a safer way to stop vehicles by releasing road gripping media from said vehicles in various directions for the purpose of making effective contact with tires to minimize tire slippage when braking;

(i) it provides a reduction in the number of vehicle accidents by releasing road gripping media from said vehicles in various directions for the purpose of making effective contact with tires to minimize tire slippage;

(j) it provides a reduction in deaths and injuries during vehicle accidents by releasing road gripping media from said vehicles in various directions for the purpose of making effective contact with tires to minimize tire slippage when braking and provide for safe stopping;

(k) it provides a better way for vehicles behind you to safely stop and not run into the back end of your vehicle by releasing road gripping media from the back of your vehicle in various directions for the purpose of allowing it to make effective contact with the tires of the vehicle behind you to minimize their tire slippage when braking;

(l) it provides a reduction in insurance rates, cost, claims, etc. . . . , by providing a system that increases the safety of people & vehicles;

(m) it provides a reduction in salt truck expenses for cities;

(n) it provides increased tire traction for vehicles by releasing road gripping media from said vehicles in various directions for the purpose of making effective contact with tires to minimize tire slippage;

(o) it provides drivers with a safer feeling when driving their vehicle during bad weather and slippery road conditions;

(p) it provides a way to help vehicles become unstuck when they become stuck in mud, ice, rain, snow, etc. . . . ;

(q) it provides a way to help vehicles be driven safely at higher speeds during bad weather and still stop safely by releasing road gripping media from said vehicles in various directions for the purpose of making effective contact with tires to minimize tire slippage;

Further objectives and advantages of my invention will become apparent from a consideration of the drawings and ensuing description. Although the description above contains much specificity, these should not be construed as limiting the scope of the invention but as merely providing illustrations of some of the presently preferred embodiments of the invention. For example, the vehicle anti-tire-slide onboard road gripping media dispensing safety system cover, container, release mechanism, nozzle, road gripping media, trigger/selector switch, media low level display, media low level sensor, car movement sensor, wheel rotation sensor, heating element, connector, cable, and controller can have other shapes, such as circular, oval, trapezoidal, triangular, etc. . . . They can be attached in a variety of ways, such as bolted, welded, molded, etc. They can be made out of various material, such as steel, aluminum, brass, plastic, etc. They can be placed in various locations around the vehicle, inside of the vehicle, back of vehicle, front of vehicle, underneath vehicle, on top of vehicle, left of vehicle, right of vehicle, above center of tires, in front or back of tires, etc. There are also many variations of the type of vehicle anti-tire-slide onboard road gripping media dispensing safety system, such as completely manual without sensors using only the trigger switch to activate dispenser and there could be a completely automatically controlled vehicle anti-tire-slide onboard road gripping media dispensing safety system, or any other type of combination. There are also an unlimited number of inputs/outputs and ways to program the controller/computer to cause the dispense to become activated in order to release the road gripping media. For example, other vehicle inputs/outputs (existing and future developments) can be used with the dispensing system to trigger when media should be dispensed to help perfect the timely release of media.

Thus the scope of the invention should be determine by the appended claims and their legal equivalents, rather than by the examples given.

I claim:

1. An onboard vehicle road gripping dispensing system used to dispense road gripping media (automatically or manually) from the vehicle so that the road gripping media will come into contact with the tires of a vehicle and help to prevent the vehicle from sliding and allow better tire traction when braking, comprising:
(a) road gripping media;
(b) a container and cover to hold road gripping media;
(c) a release mechanism to activate the release of road gripping media from the container onto the vehicle tires or ground;
(d) a nozzle to direct road gripping media onto tires or ground;
(e) a media trigger/selector switch to send signal to controller/computer to release road gripping media;
(f) a media warning display which displays a warning to the driver of the vehicle that something is wrong with the road gripping media dispensing;
(g) a media low level sensor that monitors the level of the road gripping media inside of the container and sends a signal to indicate that the media is at a low level;
(h) a car movement sensor that monitors car movement relative to the ground and will send out a signal when this movement occurs;
(i) a wheel rotation sensor that monitors wheel rotation and will send out a signal when there is no wheel rotation;
(j) heating elements that keep the media warm and melts snow and ice when the media exit path to reach the tires and road is blocked;
(k) connector and cables to provide electrical input and output signals to the controller/computer, motor, solenoids, switches, sensors, and displays, etc. . . . ;
(a) a controller/computer that controls the logical operation of the entire media dispensing system;

2. The system claim of 1 wherein said cover, container, release mechanism, nozzle, road gripping media, trigger/selector switch, media low level display, media low level sensor, car movement sensor, wheel rotation sensor, heating elements, connector, cable, and controller/computer have a plurality of sizes, shapes and patterns.

3. The tool claim of 1 wherein the said cover, container, release mechanism, nozzle, road gripping media, trigger/selector switch, media low level display, media low level sensor, car movement sensor, wheel rotation sensor, heating elements, connector, cable, and controller/computer have a plurality of pieces that make up their sizes, shapes and patterns.

4. The tool claim of 1 wherein the said cover, container, release mechanism, nozzle, road gripping media, trigger/selector switch, media low level display, media low level sensor, car movement sensor, wheel rotation sensor, heating elements, connector, cable, and controller/computer are made from a plurality of materials and processes.

5. The tool claim of 1 wherein the said cover, container, release mechanism, nozzle, road gripping media, trigger/selector switch, media low level display, media low level sensor, car movement sensor, wheel rotation sensor, heating elements, connector, cable, and controller/computer have a plurality of locations and ways the may be attached to the vehicle.

6. The tool claim of 1 wherein the said cover, container, release mechanism, nozzle, road gripping media, trigger/selector switch, media low level display, media low level sensor, car movement sensor, wheel rotation sensor, heating elements, connector, cable, and controller/computer have a plurality of ways their components may be attached (screwed, bolted, glued, welded, staked, pressed, crimped, etc.) to make up each composition.
